(19) United States
(12) Patent Application Publication
(10) Pub. No.: US 2007/0189215 A1
(43) Pub. Date: Aug. 16, 2007

(54) Method for reducing interface load of home subscriber server

(75) Inventors: Yajuan Wu, Shenzhen (CN); Wenlin Zhang, Shenzhen (CN)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: Huawei Technologies Co., Ltd., Shenzhen (CN)

(21) Appl. No.: 10/585,288

(22) PCT Filed: Jan. 6, 2005
(86) PCT No.: PCT/CN05/00021

§ 371 Date: Oct. 30, 2006

(30) Foreign Application Priority Data
Jan. 7, 2004 (CN) 200410002310.3
Feb. 10, 2004 (CN) 200410004207.2

(51) Int. Cl. H04Q 7/00

(52) U.S. Cl. 370/331

(57) ABSTRACT

The present invention provides a method for reducing the load on Home Subscriber Server (HSS)'s interface. After receiving a request message from Serving Call Session Control Function (S-CSCF) comprising the request for storing the name of the S-CSCF and for downloading the user's subscription information, HSS first stores the name of S-CSCF in the request message, then returns to the S-CSCF a response message comprising the user's subscription information. This invention simplifies the steps of inquiring about the user's subscription information, optimizes the service procedure, and reduces the load on HSS's interface. In addition, when receiving the inquiry message from I-CSCF, HSS returns directly to I-CSCF response message comprising the S-CSCF name and the S-CSCF capability information set that has the capability to meet the most strict service subscription requirement of the UE, further reducing the load on HSS's interface. This invention has no impact on the existing network architecture and services, nor is it needed to modify the existing interface specifications, thus being highly compatible and extendable.

### FIELD OF THE TECHNOLOGY

The present invention relates to mobile communications technology, particularly, to methods for reducing the load on the interface of Home Subscriber Server (HSS).

### BACKGROUND OF THE INVENTION

With the development of broadband network, mobile communications has gone beyond the traditional voice communications. Combined with data services, such as Presence Service, Short Message Service, WEB browsing service, Location Service, PUSH service, and File-sharing service, Mobile communications of various media types, such as audio, video, image and text, can be implemented so as to satisfy various demands of users.

For example, Short Message Service can provide such services as instant messaging, chat room, and Multi-Media Short Message service; Video services are provided together with entertainment, Multi-Media Information, and Daily Communications; Electronic Commerce includes such services as product catalog, search engine, shopping cart, as well as order form management and payment; Game services include individual games and group games; Location services include such services as looking for a person, providing guidance, and transmitting alarm; Personal Assistant provides services such as address book, schedule, bookmark, file storing, event reminder, and E-mail.

Organizations like the 3rd Generation Partnership Project (3GPP) and the 3rd Generation Partnership Project 2 (3GPP2) have successively put forward the architecture based on IP Multimedia Subsystem (IMS), aimed at using a standardized open architecture in mobile networks for implementing various multimedia applications so that more choices and more plentiful perceptions could be enjoyed by users.

The IMS architecture superimposes on packet switched network, including functional entities such as the Call Session Control Function (CSCF), Media Gateway Control Function (MGCF), Media Resources Function (MRF), and HSS.

CSCF can be divided into 3 logical functions, serving CSCF (S-CSCF), proxy CSCF (P-CSCF), and interrogating CSCF (I-CSCF), which can be configured in different physical devices, or in different functional modules of one physical device. S-CSCF is the service control center of IMS, used to perform session control, maintain session states, manage subscriber information, and generate charging data; P-CSCF is the access point of end-users to access IMS, used in initiating subscriber registration, QoS (Quality of Service) control, and security management; I-CSCF is responsible for interworking between IMS domains, administering assignment of S-CSCF, hiding network topology and configuration information from the outside, and generating charging data.

MGCF is used in implementing the interworking between an IMS network and other kinds of networks. MRF is used in providing media resources, such as audio receiving/transmitting, coding/decoding, and multimedia conference bridge.

HSS is a very important subscriber database, storing the subscription information and configuration information of users, such as users' identifier, number and addressing information, security information, location information, and profile information. HSS is used in supporting the processing of calls and sessions of each network entity. There may exist one or more HSS in the home network, and the number of HSS depends on the number of mobile subscribers, capability of network devices, and specific structure of networking.

As the network architecture of IMS is independent to the bearer network, the IMS architecture defined by 3GPP can also be applied to other packet-switched networks other than the packet domain network defined by 3GPP. Therefore, application of IMS described here is not limited to networks and applications associated with 3GPP. Services and applications of other types of access network and bearer network can be implemented by the IMS architecture as well.

A User Equipment (UE) includes at least one Public User Identity, which is used in identifying the service requested by the UE. UE registers each Public User Identity, respectively, i.e. the registration procedure of each Public User Identity is independent. As these public user identities belong to one user, however, it is defined in the specifications that, after UE has successfully registered a Public User Identity and is assigned an S-CSCF by the network, the network has to return the same S-CSCF to the UE when it makes registration with the UE's other public user identities. Registration has a life cycle, and the S-CSCF assigned for UE each time by the network is only responsible for processing the IMS session signaling related with the UE during the life cycle of the registration. Refer to 3GPP TS 23.228 for the specific implementation.

Each UE that has subscribed to IMS services is assigned one or more than one Private User Identity by the operator of the home network, which is used in the procedures of registration, authorization, management, and charging and is in the format of Network Access Identifier (NAI). The Private User Identity is usually not open to the outside while the public user identifier is open to the outside and used in sessions of various services.

Next is an example of the procedure based on IMS for the first registration of a Public User Identity, describing the specific interaction between HSS and network entities.

FIG. 1 is the flowchart based on IMS for the first registration of a Public User Identity in the prior art. In this preferred embodiment, the Session Initiation Protocol (SIP) is used as the signaling control protocol of IP multimedia sessions; the interface Cx between HSS and I-CSCF/S-CSCF uses the Diameter protocol to transfer the related information. The function for hiding network topology is not needed in this preferred embodiment and UE is located in a visited network.

Step 101: After establishing the physical connection with the bearer, UE sends a Register message to the P-CSCF in the visited network severing the UE. The Register message includes: Public User Identity, Private User Identity, domain name of the home network, and the IP address of the UE requesting registration.

Step 102: On receiving the Register message, the P-CSCF analyzes the domain-name information of home network in the Register message to obtain the address of the access point of the home network (i.e. the I-CSCF), and then forwards the Register message of the UE to the I-CSCF of the home network. The forwarded Register message includes: name or address of P-CSCF, Public User Identity, Private User Identity, identifier of the visited network where P-CSCF is located, and the IP address of the UE requesting registration.

Step 103: I-CSCF sends a Cx-Query message to HSS. The User-Authorization-Type in Cx-Query message is REGISTRATION, which indicates that Cx-Query message is a message requesting for a registration. The Cx-Query message includes such information as Public User Identity, Private User Identity, and identifier of the network where P-CSCF is located and so on.

Step 104: After receiving the Cx-Query message from I-CSCF, HSS first decides according to the subscription information of the user and the policy of the operator whether the UE is permitted to perform a registration in the current network, if not permitted, just returns to I-CSCF a Cx-Query Resp message indicating rejection to the registration. Then I-CSCF returns a message of registration failure to the UE via P-CSCF, and the procedure is over.

If the UE is permitted to perform a registration in the current network, HSS will return appropriate information to I-CSCF according to whether HSS has stored the name of S-CSCF that has served the UE and according to whether the contents of subscription document of the UE requesting a registration stored in HSS have been changed or updated.

If the UE requesting a registration has at least one Public User Identity that has been registered in HSS, i.e. HSS has stored the name of the S-CSCF that is serving the UE and the registration is valid, and the contents of subscription document of the UE requesting a registration stored in HSS have not been changed or updated, HSS will return to I-CSCF a Cx-Query Resp message including the name of the S-CSCF that is serving the UE before going to Step 107.

If the UE has at least one Public User Identity of which the registration status is unregistered or the registration has expired but the name of the S-CSCF used by the UE last time is still stored in HSS, or the UE has been assigned an S-CSCF by HSS as an unregistered UE receiving a terminating call, then HSS will return to I-CSCF a Cx-Query Resp message including the name of the S-CSCF that has served the UE before going to Step 107.

If HSS has stored the name of the S-CSCF that has served the UE and the contents of subscription document of the UE requesting a registration stored in HSS have been changed or updated, HSS will return to I-CSCF a Cx-Query Resp message including the name of S-CSCF and the information of the available S-CSCF capability information set, then I-CSCF will further decide whether the returned name of S-CSCF can be used. If it can be used, go to Step 107, otherwise, go to Step 105 and I-CSCF will re-select an S-CSCF.

If there is no S-CSCF stored in HSS that has been assigned to the UE, HSS will return to I-CSCF a Cx-Query Resp message including only the information of the available S-CSCF capability information set before going to Step 105.

Step 105: I-CSCF sends to HSS a Cx-Select-Pull request message, in which the User-Authorization-Type is REGISTRATION_AND_CAPABILITIES, indicating that I-CSCF asks HSS to return the S-CSCF capability information set that has the capability to meet the most strict service subscription requirement of the UE requesting registration, as the input information for selecting an S-CSCF, the Cx-Select-Pull message includes such information as Public User Identity and Private User Identity and so on.

Step 106: After receiving the Cx-Select-Pull message from I-CSCF, HSS returns to I-CSCF a Cx-Select-Pull Resp message, which includes the S-CSCF capability information set that has the capability to meet the most strict service subscription requirement of the UE requesting registration.

Step 107: I-CSCF makes domain-name analysis based on the name of S-CSCF returned by HSS, or selects an S-CSCF from all the S-CSCFs which has the capability to provide service to the UE and also meet the most strict service subscription requirement of the UE requesting registration, then makes domain-name analysis based on the name of the selected S-CSCF, obtains the address of the S-CSCF, and sends a Register message to the S-CSCF. The Register message includes such information as the domain name or address of P-CSCF, Public User Identity, Private User Identity, identifier of the network where P-CSCF is located, and the EP address of the UE requesting a registration and so on.

If I-CSCF is unable to obtain a new S-CSCF using the information of capability information set that has the capability to meet the most strict service subscription requirement of the UE requesting registration, I-CSCF will return a message of registration failure to the ULE via P-CSCF and the procedure is over.

Step 108: S-CSCF sends a Cx-Put message to HSS so that HSS stores the name of S-CSCF used by the UE, wherein the Cx-Put message includes such information as Public User Identity and/or Private User Identity, and the name of S-CSCF and so on.

Step 109: HSS returns a Cx-Put Resp message, indicating that it has stored the name of the S-CSCF.

Step 110: After receiving the Cx-Put Resp message from HSS, S-CSCF sends a Cx-Pull message to HSS, requesting to obtain the user's subscription information, wherein the Cx-Pull message includes such information as Public User Subscription and/or Private User Subscription and so on.

Step 111: HSS makes inquiry according to the Public User Subscription and/or Private User Subscription, and returns to S-CSCF a Cx-Pull Resp message including the user's subscription information, i.e. the Cx-Pull Resp message includes user profile information and security information and so on, wherein the user profile information is used for the user to access various service control platforms.

Step 112: S-CSCF, according to the filtering rule obtained from the user profile information, sends the registration information to a related service control platform and performs appropriate service control.

Step 113: S-CSCF returns to the UE a 2000K message via I-CSCF and P-CSCF.

By far, the first registration of a Public User Identity of the UE is completed.

In the above procedures, the role of the Cx-Put message in Step 108 is to request HSS to store the name of S-CSCF serving the user, the Cx-Pull Resp message in Step 109 is only for indicating an acknowledgement of the above request message; the role of the Cx-Pull message in Step 110 is to request HSS for the user's subscription information needed for subsequent processing, and it is the Cx-Pull Resp message in Step 111 that sends the user's subscription information to S-CSCF.

As can be seen from the above description, in the implementation of the prior art, HSS uses one message to confirm the storing of the name of S-CSCF and another one message to return the user's subscription information to S-CSCF, which increases the load on the interface Cx between HSS and S-CSCF.

The above steps of 105 and 106 are triggered due to the incompletion of the information returned by HSS to I-CSCF, i.e. if HSS returns to I-CSCF only the information including the available S-CSCF capability, it will be necessary to trigger Steps 105 and 106 so as to obtain the information set of the S-CSCF capability that has the capability to meet the most strict service subscription requirement of the UE requesting registration.

Meanwhile, the information carried by the request messages in Steps 105 and 103 is basically the same except the difference in the information of the User-Authorization-Type. This difference, however, is only a distinction in type and brings no new information to HSS. Likewise, in Step 106, the information returned by HSS includes no more valuable information for I-CSCF. Therefore, Steps 105 and 106 are redundant steps, increasing the load on the interface between HSS and I-CSCF.

Although the above analysis is based on the procedures for the first registration of a public user identifier of UE, there exists the same problem in the procedures that involve the inquiry of HSS about user's subscription information, such as the procedures for non-first registration of a public user identifier of UE and sessions performed by IMS users, the procedures of inquiring HSS about the name of S-CSCF that serves UE.

### SUMMARY OF THE INVENTION

This present invention provides two technical solutions as follows:

A method for reducing load of Home Subscription Server (HSS)'s interface, including:

After receiving a request message from Serving Call Session Control Function (S-CSCF) including a request for a storing name of the S-CSCF and for downloading a user's subscription information, a HSS first storing the name of S-CSCF in the request message, then returning to the S-CSCF a response message including the user's subscription information.

A method for reducing load of Home Subscription Server (HSS)'s interface, including:

After receiving a message from a I-CSCF for inquiring about the information of S-CSCF, a HSS returning to the I-CSCF an inquiry response message including a information needed for determining an S-CSCF; the I-CSCF determining a S-CSCF that has the capability to serve a UE and forwarding the request message of the UE to the determined S-CSCF.

In accordance with this invention, when receiving the request message from S-CSCF including the request for storing the name of the S-CSCF and for downloading the user's subscription information, HSS first stores the S-CSCF name in the request message, and then returns the requested user's subscription information to the S-CSCF sending the request, thus may simplifying the steps for inquiring about user's subscription information, optimizing the service procedure, and reducing the load of HSS's interface.

In addition, during registration of a certain public user identifier of the user or during a session of the user, after receiving the request message from I-CSCF including the request for the S-CSCF name or the S-CSCF capability information set, HSS returns directly to I-CSCF the response message including the S-CSCF name and/or capability information set that has the capability to meet the most strict service subscription requirement of the user, and then continues with the subsequent steps, thus may simplifying the redundant steps in the prior art, optimizing the registration procedure of the user as well as the session procedure, and reducing the load of HSS's interface.

The present invention makes no impact on the existing network architecture and service implementation, nor is it needed to modify the existing interface specifications, thus being highly compatible and expandable. dr

### BRIEF DESCRIPTION OF THE DRAWINGS

FIG. 1 is the flowchart of the first registration of public user identifier based on the IMS architecture in the prior art;

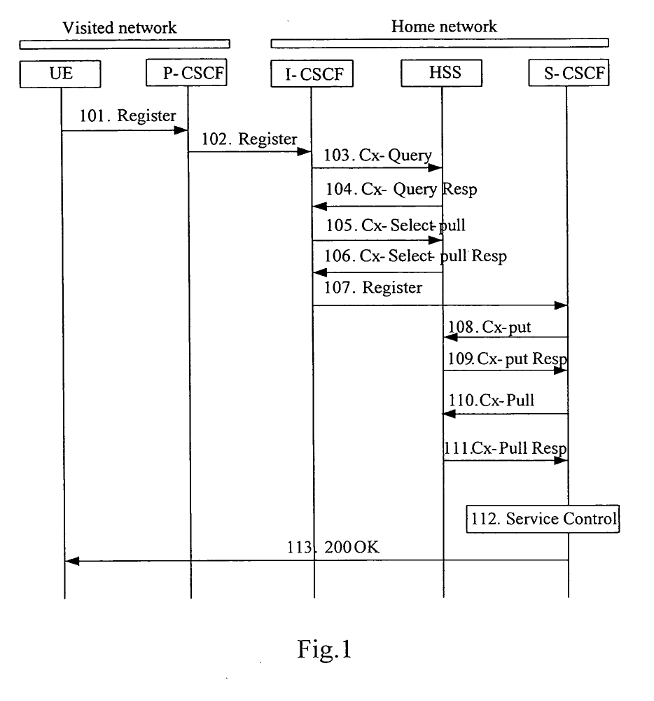

FIG. 2 is the flowchart of the first registration of public user identifier based on the IMS architecture in a preferred embodiment in accordance with this invention;

FIG. 2A is the flowchart of the first registration of public user identifier based on the IMS architecture in another preferred embodiment in accordance with this invention;

FIG. 3 is the flowchart of registration of public user identifier other than the first time based on the IMS architecture in accordance with this invention;

FIG. 4 is part of the flowchart of a call in which the user is called based on the IMS architecture in a preferred embodiment in accordance with this invention;

FIG. 4A is part of the flowchart of a call in which the user is called based on the IMS architecture in another preferred embodiment in accordance with this invention.

### EMBODIMENT OF THE INVENTION

In order to make the technical solution of this invention clearer, a further detailed description is hereinafter given with reference to specific preferred embodiments and the accompanying drawings.

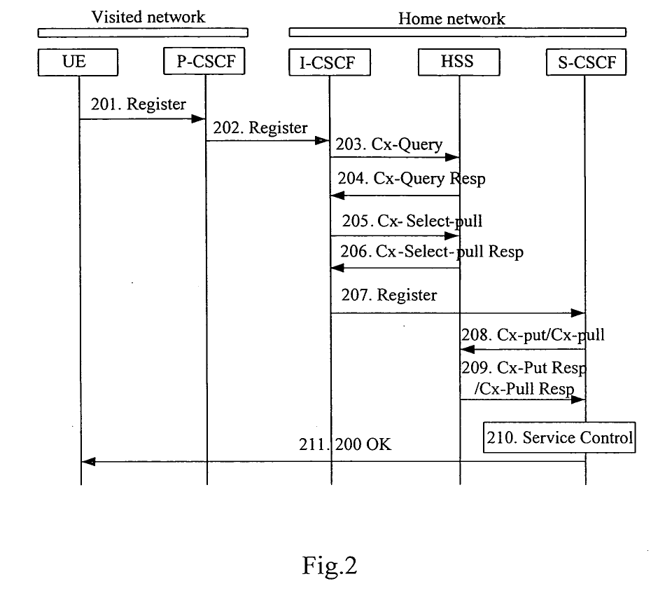

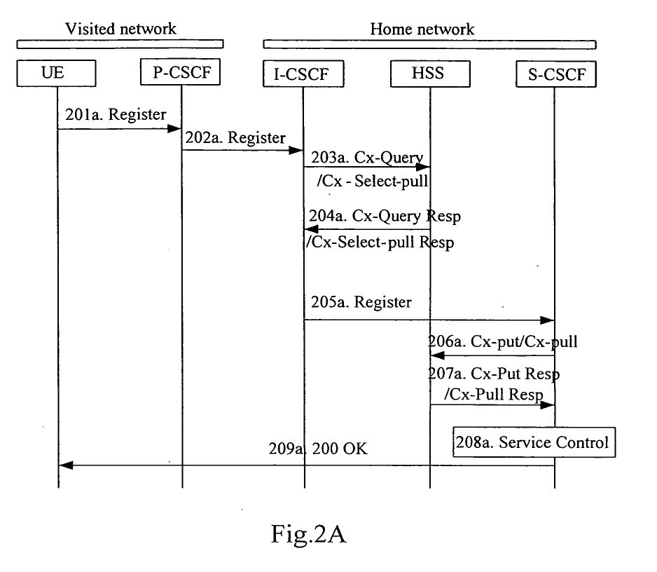

FIG. 2 is the flowchart of the first registration of a public user identifier based on the IMS architecture in a preferred embodiment in accordance with this invention. In this preferred embodiment, SIP is used as the signaling control protocol for IP multimedia sessions, the Diameter protocol is used in the Cx interface between HSS and I-CSCF/S-CSCF to transfer related information, the function of hiding network topology is not needed in this preferred embodiment, and UE is located in a visited network.

Step 201: After establishing a physical connection with the bearer, UE sends a Register message to the P-CSCF in the visited network where the UE is located. The Register message includes such information as Public User Identity, Private User Identity, domain name of home network, and IP address of the UE requesting registration and so on.

Step 202: P-CSCF receiving the Register message makes analysis of the domain-name information of home network in the Register message so as to obtain the address of the access point of the home network, I-CSCF, and then forwards the Register message of the UE to the I-CSCF in the home network. The forwarded Register message includes such information as the name or address of P-CSCF, Public User Identity, Private User Identity, identity of the visited network where the P-CSCF is located, and IP address of the UE requesting registration and so on.

Step 203: I-CSCF sends a Cx-Query message to HSS. The User-Authorization-Type in the Cx-Query message is REGISTRATION, indicating the Cx-Query message is a registration request message. The Cx-Query message includes such information as public user identifier, private user identifier, and identifier of the network where the P-CSCF is located and so on.

Step 204: After receiving the Cx-Query message from I-CSCF, HSS first decides according to the subscription information of the user and the policy of the operator whether the UE is permitted to perform a registration request in the current network, if not permitted, directly returns to I-CSCF a Cx-Query Resp message including the rejection to the register message, I-CSCF returns a registration failure message to UE via P-CSCF, and the procedure is over;

If the UE is permitted to perform a registration request in the current network, HSS will return to I-CSCF appropriate information according to whether HSS has stored the name of the S-CSCF that has served the UE and whether the stored contents of the subscription document of the UE requesting registration have been changed or updated.

If at least one Public User Identity of the UE requesting registration has been registered in HSS, i.e. HSS has stored the name of the S-CSCF that has served the UE and the S-CSCF is still within the term of validity, and the stored contents of the subscription document of the UE requesting registration have not been changed or updated, then after HSS returns to I-CSCF a Cx-Query Resp message including the name of the S-CSCF currently serving the user, Step 207 will be executed;

If the registration status of at least one Public User Identity of the user is unregistered or the registration thereof has expired while HSS still has the name of the S-CSCF used by the user last time or the user has been assigned an S-CSCF by HSS as an unregistered user receiving a terminating call, then after HSS returns to I-CSCF a Cx-Query Resp message including the name of the S-CSCF that has served the user, Step 207 will be executed;

If HSS has stored the name of the S-CSCF that has served or is serving the UE and HSS believes that it might be needed for I-CSCF to re-select an S-CSCF to serve the user, e.g. the content of the subscription document of the UE requesting registration stored in HSS have been changed or updated, then, after HSS returns to I-CSCF a Cx-Query Resp message including the information of the S-CSCF name and the available S-CSCF capability information set, I-CSCF further decides whether the returned name of S-CSCF can be used, if it can be used, Step 207 will be executed, otherwise, Step 205 will be executed and I-CSCF will re-select an S-CSCF;

If there is not the name of the S-CSCF in HSS that has been assigned and has served the UE, then, after HSS returns to I-CSCF a Cx-Query Resp message including only the information of the available S-CSCF capability information set, Step 205 will be executed.

Step 205: I-CSCF sends to HSS a Cx-Select-Pull request message. The User-Authorization-Type in Cx-Select-Pull request message is REGISTRATION_AND_CAPABILITIES, indicating definitely that I-CSCF requests HSS to return the S-CSCF capability information set that has the capability to meet the most strict service subscription requirement of the UE requesting registration as the input information for selecting an S-CSCF. The Cx-Select-Pull request message includes information such as Public User Identity and Private User Identity and so on.

Step 206: After receiving the Cx-Select-Pull request message from I-CSCF, HSS returns to I-CSCF a Cx-Select-Pull Resp message, which includes the S-CSCF capability information set that has the capability to meet the most strict service subscription requirement of the UE requesting registration.

Step 207: I-CSCF makes domain-name analysis according to the returned name of S-CSCF from HSS or selects an S-CSCF from all the S-CSCFs that has the capability to serve the user from the S-CSCF capability information set that has the capability to meet the most strict service subscription requirement of the UE requesting registration before making domain-name analysis of the name of the S-CSCF so as to obtain the address of S-CSCF, and sends to the S-CSCF a Register message, which includes information such as the domain name or address of P-CSCF, Public User Identity, Private User Identity, identity of the network where the P-CSCF is located, and IP address of the UE requesting registration and so on;

If I-CSCF is unable to obtain a new S-CSCF according to the information of the capability information set that has the capability to meet the most strict service subscription requirement of the UE requesting registration, I-CSCF will return to the UE a registration failure message, and the procedure is over.

Step 208: S-CSCF sends to HSS a request message including the request for storing the name of the S-CSCF and for downloading the user's subscription information. The request message includes information such as Public User Identity and/or Private User Identity, and name of S-CSCF; and can be carried by Cx-Put message or Cx-Pull message and so on.

Step 209: After receiving the message from S-CSCF requesting for storing the name of the S-CSCF and for downloading the user's subscription information, HSS first stores the S-CSCF name in the request message, then makes inquiry locally according to the Public User Identity and/or private user identifier, and directly returns to S-CSCF a response message including the user's subscription information. The user's subscription information in the response message includes user profile information, security information and etc., wherein the user profile information is used for the user to access various service control platforms. The response message is carried by a Cx-Put Resp message or a Cx-Pull Resp message.

Step 210: S-CSCF, according to the filtering rule obtained from the user profile information, sends the Register message to the related service control platform to perform appropriate service control procedures.

Step 211: S-CSCF returns to UE the 200 OK message via I-CSCF and P-CSCF.

By far, the first registration of one public user identifier of the user has been completed. In the above registration procedure, the step of S-CSCF making inquiry of HSS for user profile information is simplified, thus the load on HSS's interface is reduced.

Meanwhile, Steps 205 and 206 can be simplified as well in the above procedure, making I-CSCF obtain the needed information by one message. The procedure with Steps 205 and 206 deleted is shown in FIG. 2A. As the difference between FIG. 2 and FIG. 2A is only that Steps 205 and 206 are deleted and Steps 201a-203a in FIG. 2A are completely the same as Steps 201-203 in FIG. 2, no repeated description is given here. In Step 204a, the following operations are performed:

After receiving the Cx-Query message from I-CSCF, HSS first decides, according to the subscription information of the user and the policy of the operator, whether the UE is permitted to perform a registration request in the current network, if not permitted, directly returns to I-CSCF a Cx-Query Resp message including the rejection to the Register message, then I-CSCF returns a registration failure message to the UE via P-CSCF, and the procedure is over;

If the UE is permitted to perform a register request in the current network, HSS will return to I-CSCF appropriate information according to whether HSS has stored the name of S-CSCF that has served the UE and whether the stored contents of the subscription document of the UE requesting registration in HSS have been changed or updated.

If at least one public user identifier of the UE requesting registration has been registered in HSS, i.e. HSS has stored the name of the S-CSCF that has served the UE and the S-CSCF is still within the term of validity, and HSS determines that it is not needed for I-CSCF to re-select an S-CSCF to serve the user, e.g. the stored contents of the subscription document of the UE requesting registration in HSS have not been changed or updated, then HSS will return to I-CSCF a Cx-Query Resp including the name of the current S-CSCF that serves the user before Step 205a is executed;

If the registration status of at least one public user identifier of the user is unregistered or the registration thereof has expired, but HSS has stored the name of the S-CSCF used by the user last time, or the user has been assigned an S-CSCF by HSS as an unregistered user receiving a terminating call, then HSS will return to I-CSCF a Cx-Query Resp message including the name of the S-CSCF that has served the user before Step 205a is executed;

If HSS has stored the name of the S-CSCF that has served or is serving the ULE and HSS is not sure whether it is needed for I-CSCF to re-select an S-CSCF to serve the user, e.g. the contents of the subscription document of the UE requesting registration stored in HSS have been changed or updated, then, after HSS returns to I-CSCF a response message including the information of the S-CSCF name and the S-CSCF capability information set that has the capability to meet the most strict service subscription requirement of the UE requesting registration, Step 205a will be executed;

If there is not the name of the S-CSCF in HSS that has been assigned and has served the UE, then, after HSS returns to I-CSCF a response message including the S-CSCF capability information set that has the capability to meet the most strict service subscription requirement of the UE requesting registration, Step 205a will be executed.

In the above preferred embodiment, the inquiry message received by HSS from I-CSCF is carried by Cx -Query message, the response message returned to I-CSCF from HSS is carried by Cx-Query Resp message. In practical applications, the inquiry message received by HSS from I-CSCF can also be carried by Cx-Select-pull message; the response message returned to I-CSCF from HSS can also be carried by Cx-Select-pull Resp message.

Correspondingly, Step 205a in FIG. 2A is equal to Step 207 in FIG. 2, and the operations performed in Step 205a is as follows:

I-CSCF determines, according to the returned information from HSS, the S-CSCF that has the capability to serve the UE and makes domain-name analysis according to the name of the S-CSCF to obtain the address of the S-CSCF. The specific procedure is: If HSS returns a response message including only the name of S-CSCF, I-CSCF determines that the S-CSCF is a S-CSCF can serve the UE. If HSS returns a response message including only the S-CSCF capability information set that has the capability to meet the most strict service subscription requirement of the UE requesting registration, I-CSCF selects a new S-CSCF that has the capability to meet the current service demand of the UE based on the S-CSCF capability information set, and determines that the newly-selected S-CSCF is the S-CSCF that has the capability to serve the user. If HSS returns a response message including the name of the S-CSCF that has served the UE as well as the S-CSCF capability information set that has the capability to meet the most strict service subscription requirement of the UE requesting registration, I-CSCF decides according to the returned S-CSCF name whether the S-CSCF has the capability to meet the current service demand of the UE, if yes, determines that the returned S-CSCF is the S-CSCF that has the capability to serve the user; otherwise, selects a new S-CSCF that has the capability to meet the current service requirement of the UE according to the S-CSCF capability information set in the response message and determines that the newly-selected S-CSCF is the S-CSCF that has the capability to serve the user.

Steps 206a-209a are completely the same as Steps 208-211 in FIG. 2, and no further description is given here.

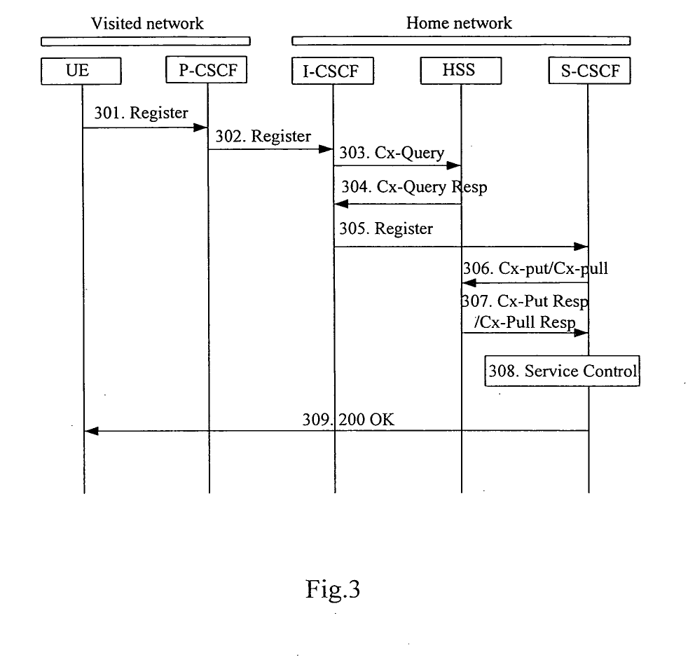

FIG. 3 is the flowchart for initiating a non-first registration of public user identifier based on the IMS architecture in accordance with the invention. In this preferred embodiment, SIP is used as the signaling control protocol for IP multimedia sessions, the Diameter protocol is used in the Cx interface between HSS and I-CSCF and between HSS and S-CSCF for transferring related information, there is no related user profile information in the S-CSCF determined through analysis by I-CSCF, the function of hiding network topology is not needed in this preferred embodiment, and UE is located in a visited network.

Step 301: UE sends a Register message to the P-CSCF in the visited network where the UE is located. The Register message includes information such as public user identifier, private user identifier, domain name of home network, and IP address of the UE requesting registration and so on.

Step 302: P-CSCF receiving the Register message makes analysis of the domain-name information of home network in the Register message so as to obtain the address of the access point of the home network, I-CSCF, and then forwards the Register message of the UE to the I-CSCF in the home network. The forwarded Register message includes information such as the name or address of P-CSCF, public user identifier, private user identifier, identifier of the visited network where the P-CSCF is located, and IP address of the UE requesting registration and so on.

Step 303: I-CSCF sends a Cx-Query message to HSS. The Cx-Query message includes information such as public user identifier, private user identifier, and identifier of the network where the P-CSCF is located and so on.

Step 304: After receiving the Cx-Query message from I-CSCF and determining that the UE has registered, HSS directly returns to I-CSCF a Cx-Query Resp message including the indication that an S-CSCF has been assigned for the UE and the Cx-Query Resp message includes the name of the S-CSCF that has served the user.

Step 305: I-CSCF makes domain-name analysis based on the name of S-CSCF returned from HSS, obtains the address of the S-CSCF, and sends a Register message to the S-CSCF. The Register message includes information such as the domain name or address of P-CSCF, public user identifier, private user identifier, identifier of the network where P-CSCF is located, and IP address of the UE requesting registration and so on.

Step 306: S-CSCF sends to HSS a request message including the request for storing the name of the S-CSCF and for downloading the user's subscription information. The request message includes information such as public user identifier and/or private user identifier, and name of S-CSCF; and can be carried by Cx-Put message or Cx-Pull message and so on.

Step 307: After receiving the message from S-CSCF requesting for storing the name of the S-CSCF and for downloading the user's subscription information, HSS first stores the S-CSCF name in the request message, then makes inquiry locally according to the public user identifier and/or private user identifier, and directly returns to the S-CSCF a response message including the user's subscription information. The user's subscription information in the response message includes user profile information, security information and etc., wherein the user profile information is used for the user to access various service control platforms. The response message is carried by a Cx-Put Resp message or a Cx-Pull Resp message.

Step 308: S-CSCF, according to the filtering rule obtained from the user profile information, sends the registration information to the related service control platform to perform appropriate service control procedures.

Step 309: S-CSCF returns to UE a 200 OK message via I-CSCF and P-CSCF.

By far, the re-registration of a public user identifier of the UE has been completed and the step of S-CSCF making inquiry to HSS for user profile information is simplified, thus the load on HSS's interface is reduced.

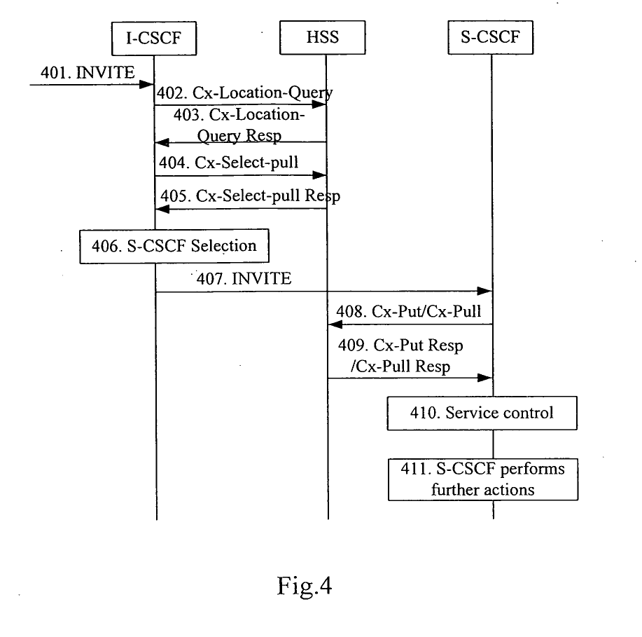

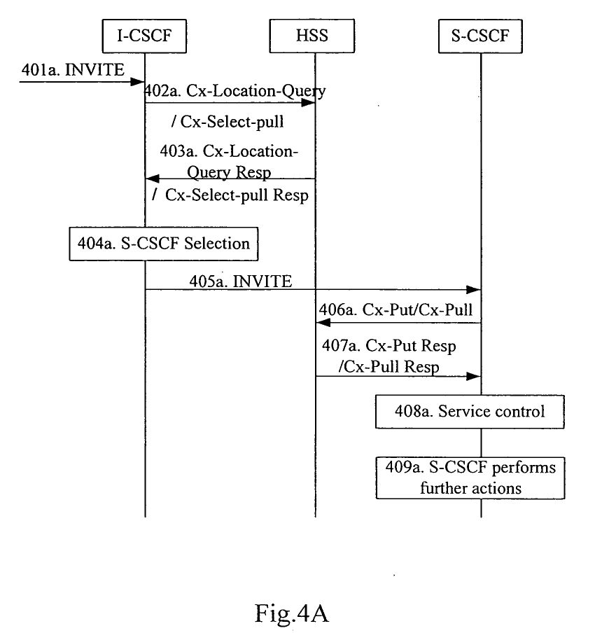

FIG. 4 shows part of the flowchart of a preferred embodiment which is based on the IMS architecture and in which the UE is called in accordance with this invention. In this preferred embodiment, SIP is used as the signaling control protocol for IP multimedia sessions, the Diameter protocol is used in the Cx interface between HSS and I-CSCF and between HSS and S-CSCF for transferring related information, there is no related user profile information stored in the S-CSCF that I-CSCF selected, and the public user identifier used by the UE has not been registered.

Step 401: I-CSCF receives a forwarded INVITE message from the calling UE, and the forwarded INVITE message includes the information of a public user identifier.

Step 402: I-CSCF sends to HSS a Cx-Location-Query message inquiring the information of the current location of the UE.

Step 403: Based on the pre-configuration of system, after HSS returns to I-CSCF a Cx-Location-Query Resp message including the indication that the public user identifier has not been registered, Step 404 is executed; or after HSS returns to I-CSCF a message including the name of the S-CSCF that has been assigned for the UE before and the information of the available S-CSCF capability information set, Step 404 is executed; or after HSS returns to I-CSCF a Cx-Location-Query Resp message including the name of the S-CSCF that has been assigned for the UE before, Step 407 is executed.

Step 404: I-CSCF sends a Cx-Select-Pull message to HSS to request for the S-CSCF capability information set that has the capability to meet the most strict service subscription requirement. The parameters carried in the request message mainly include information such as public user identifier and so on.

Step 405: After receiving the Cx-Select-Pull message, HSS returns to I-CSCF a Cx-Select-Pull Resp message which is needed by I-CSCF and includes the S-CSCF capability information set that has the capability to meet the most strict service subscription requirement of the UE.

Step 406: I-CSCF selects, according to the S-CSCF capability information set returned by HSS, the S-CSCF that has the capability to serve the UE and obtains the address of the S-CSCF by analysis based on the name of the S-CSCF before performing Step 407;

If I-CSCF can not obtain the needed address of the S-CSCF based on the S-CSCF capability information set returned by HSS, I-CSCF will designate an S-CSCF to serve the unregistered public user identifier, and then Step 407 is executed.

Step 407: I-CSCF forwards the received INVITE message to the determined S-CSCF.

Step 408: The S-CSCF receiving the INVITE message sends to HSS a request message including the request for storing the name of the S-CSCF and for downloading the user's subscription information. The INVITE message includes information such as public user identifier and/or private user identifier, and S-CSCF name, and can be carried by a Cx-Put message or a Cx-Pull message and so on.

Step 409: After receiving the message from the S-CSCF requesting for storing the name of the S-CSCF and for downloading the user's subscription information, HSS first stores the S-CSCF name in the request message, then makes inquiry locally according to the public user identifier and/or private user identifier, and directly returns to the S-CSCF a response message including the user's subscription information. The user's subscription information in the response message includes user profile information, security information and etc., wherein the user profile information is used for the UE to access various service control platforms. The response message is carried by a Cx-Put Resp message or a Cx-Pull Resp message.

Step 410: S-CSCF, according to the filtering rule obtained from the user profile information, sends the registration information to the related service control platform to perform appropriate service control procedures.

Step 411: S-CSCF continues with the subsequent operations.

The above call procedure simplifies the step of S-CSCF inquiring the user profile information from HSS, thus reducing the load on the HSS's interface.

Furthermore, Steps 404 and 405 in the above procedure can be simplified so that I-CSCF could obtain the needed information by one interaction. The procedure with Steps 404 and 405 simplified is shown in FIG. 4A. As the difference between FIG. 4A and FIG. 4 only lies in that there are no Steps 404 and 405 in FIG. 4A, so Steps 401a-402a in FIG. 4A are completely the same as Steps 401-402 in FIG. 4, no repeated description is given here. In Step 403a, the following operation is performed:

After receiving the message inquiring the information of the current location of the UE sent by I-CSCF, HSS decides whether it has stored the name of the S-CSCF that has served the UE, if HSS has stored the name of the S-CSCF that has served the UE, then, according to the system configuration, HSS returns to I-CSCF a response message including the S-CSCF name or including the information of the S-CSCF name and the S-CSCF capability information set that has the capability to meet the most strict service subscription requirement of the UE before Step 404a is executed;

If there is no S-CSCF that has served the UE been stored in HSS, HSS will just return a response message including the S-CSCF capability information set that has the capability to meet the most strict service subscription requirement of the UE before Step 404a is executed.

Correspondingly, Step 404a in FIG. 4A is equal to Step 406 in FIG. 4 and the operation performed in Step 404a is as follows:

I-CSCF determines the S-CSCF that has the capability to serve the UE according to the information returned from HSS, and makes domain-name analysis based on the name of the S-CSCF to obtain the address thereof. The specific procedure is: If HSS returns a response message including only the name of S-CSCF, I-CSCF determines the S-CSCF is the S-CSCF that has the capability to serve the user; if HSS returns a response message including only the information of the S-CSCF capability information set that has the capability to meet the most strict service subscription requirement of the UE requesting registration, I-CSCF selects a new S-CSCF that has the capability to meet the current service requirement of the user according to the S-CSCF capability information set and determines the newly selected S-CSCF is the S-CSCF that has the capability to serve the user; if HSS returns a response message including the name of the S-CSCF that has served the UE and the S-CSCF capability information set that has the capability to meet the most strict service subscription requirement of the UE requesting registration, I-CSCF decides according to the returned S-CSCF name whether the S-CSCF has the capability to meet the current service requirement of the UE, if yes, determines the S-CSCF as S-CSCF that has the capability to serve the user, otherwise, selects a new S-CSCF that has the capability to meet the current service requirement of the UE according to the S-CSCF capability information set in the response message and determines the newly-selected S-CSCF is the S-CSCF that has the capability to serve the user.

If I-CSCF can not obtain the needed S-CSCF address by analysis of the HSS-return the S-CSCF capability information set that has the capability to meet the most strict service subscription requirement of the UE requesting registration, I-CSCF will designate an S-CSCF to serve the unregistered public user identifier.

The above inquiry message from I-CSCF received by HSS is carried by a Cx-Location-Query message and the response message returned by HSS to I-CSCF is carried by a Cx-Location-Query Resp message. Alternatively, the above inquiry message from I-CSCF received by HSS can be carried by a Cx-Select-Pull message and the response message returned by HSS to I-CSCF can be carried by a Cx-Select-Pull Resp message.

Steps 405a-409a are completely the same as Steps 407-411 in FIG. 4, and no further description is given here.

The foregoing is only preferred embodiments of this invention and should not be construed as limiting the protection scope thereof. Any modification, equivalent substitution, or improvement without departing from the spirit and principle of this invention should be covered by the protection scope of this invention.

1. A method for reducing load of Home Subscriber Server (HSS)'s interface, comprising:
upon receiving a request message from Serving Call Session Control Function (S-CSCF) comprising a request for a storing name of the S-CSCF and for downloading a user's subscription information, a HSS first storing the name of S-CSCF in the request message, then returning to the S-CSCF a response message comprising the user's subscription information.

2. The method according to claim 1, further comprising: upon receiving a request message from Interrogating Call Session Control Function (I-CSCF) for inquiring about the information of S-CSCF, the HSS returning to the I-CSCF an inquiry response message comprising the information needed for determining an S-CSCF; according to the returned information in the response message, the I-CSCF determining the S-CSCF that has the capability to serve a User Equipment (UE) and forwarding the request message of the UE to the determined S-CSCF.

3. The method according to claim 2, wherein, when a Public User Identity performs registration for the first time,
if there is at least one Public User Identity of the UE requesting registration that has been registered in the HSS and the registration is still valid, and if the HSS decides there is no need for the I-CSCF to re-select an S-CSCF to serve the UE, said information needed for determining the S-CSCF comprises the name of the S-CSCF that is serving the UE;
if there is at least one Public User Identity of the UE of which the registration status is unregistered or the registration has expired thereof but the HSS still stores the name of the S-CSCF that was used by the UE last time, or if the UE has been assigned an S-CSCF by the HSS as an unregistered party that is called, said information needed for determining the S-CSCF comprises the name of the S-CSCF that has served the UE;
if HSS has stored the name of the S-CSCF that has served the UE and the HSS is not sure whether it is needed for the I-CSCF to re-select an S-CSCF to serve the UE, said information needed for determining an S-CSCF comprises the name of the S-CSCF that has served the UE and the S-CSCF capability information set that has the capability to meet the most strict service subscription requirement of the UE requesting registration;
if the HSS does not store the name of the assigned S-CSCF that has served the UE, then said information needed for determining an S-CSCF comprises the S-CSCF capability information set that has the capability to meet the most strict service subscription requirement of the UE requesting registration.

4. The method according to claim 3, wherein,
if the information returned from the HSS comprises only the name of S-CSCF, said determining the S-CSCF that has the capability to serve the UE for I-CSCF further comprises: the I-CSCF using the S-CSCF in the returned information as the S-CSCF that has the capability to serve the user;
if the information returned from the HSS comprises only the S-CSCF capability information set that has the capability to meet the most strict service subscription requirement of the UE requesting registration, said determining the S-CSCF that has the capability to serve the UE for I-CSCF further comprises: the I-CSCF selecting a new S-CSCF that has the capability to meet the current service requirement of the UE according to the S-CSCF capability information set in the returned response message, and determining the newly-selected S-CSCF as the S-CSCF that has the capability to serve the UE;
if the information returned from the HSS comprises the name of S-CSCF and S-CSCF capability information set that has the capability to meet the most strict service subscription requirement of the UE requesting registration, said determining the S-CSCF that has the capability to serve the UE for I-CSCF further comprises: the I-CSCF verifying according to the returned name of S-CSCF whether the S-CSCF has the capability to meet the current service requirement of the UE, if yes, determining the returned S-CSCF is the S-CSCF that has the capability to serve the UE, otherwise, selecting a new S-CSCF that has the capability to meet the current service demand of the UE according to the S-CSCF capability information set in the response message, and determining the newly-selected S-CSCF is the S-CSCF that has the capability to serve the UE.

5. The method according to claim 2, after the HSS receives the request message for inquiring the information of S-CSCF from the I-CSCF, further comprising: deciding according to the user's subscription information and the policy of the operator that the UE is permitted to perform a registration request in the current network before subsequent steps are executed.

6. The method according to claim 2, wherein, when a Public User Identity performs registration for the first time,
the message received by the HSS from the I-CSCF for inquiring the information of S-CSCF is carried by a Cx-Query message; and said inquiry response message returned to the I-CSCF from the HSS further comprises the information needed for determining an S-CSCF is carried by a Cx-Query Resp message, or,
the message received by the HSS from the I-CSCF for inquiring the information of S-CSCF is carried by a Cx-Select-pull message; said inquiry response message returned to the I-CSCF from the HSS further comprises the information needed for determining an S-CSCF is carried by a Cx-Select-pull Resp message.

7. The method according to claim 2, wherein, when the UE is in a session,
if the HSS has stored the name of the S-CSCF that has served or is serving the UE, the HSS will, according to system configuration, return to the I-CSCF a response message comprising the name of the S-CSCF, and the I-CSCF will forward the session request message of the UE to the S-CSCF; or the HSS will return to the I-CSCF a response message comprising the information of the name of the S-CSCF and the S-CSCF capability information set that has the capability to meet the most strict service subscription requirement of the UE, and the I-CSCF will determine an S-CSCF that has the capability to serve the user and forwards the session request message of the UE to the determined S-CSCF;
if there is no S-CSCF stored in the HSS that has served the UE, the HSS will directly return to the I-CSCF a response message comprising the S-CSCF capability information set that has the capability to meet the most strict service subscription requirements of the UE before the I-CSCF determines an S-CSCF that has the capability to serve the UE and forwards the session request message of the user to the determined S-CSCF.

8. The method according to claim 2, wherein, when the UE is in a session,
the message received by the HSS from the I-CSCF for inquiring about the information of S-CSCF is carried by a Cx-Location-Query message; and said inquiry response message returned to I-CSCF from HSS further comprises the information needed for determining an S-CSCF is carried by a Cx-Location-Query Resp message, or,
the message received by the HSS from the I-CSCF for inquiring about the information of S-CSCF is carried by a Cx-Select-Pull message; and said inquiry response message returned to the I-CSCF from the HSS further comprises the information needed for determining an S-CSCF is carried by a Cx-Select-Pull Resp message.

9. The method according to claim 1, wherein,
the request message comprising the request for storing the name of the S-CSCF and for downloading the user's subscription information is carried by a Cx-Put message said response message returned to S-CSCF by HSS is carried by a Cx-Put Resp message, or,
the request message comprising the request for storing the name of the S-CSCF and for downloading the user's subscription information is carried by a Cx-Pull message, and said response message returned to the S-CSCF by the HSS is carried by a Cx-Pull Resp message.

10. The method according to claim 1, wherein said user's subscription information in the response message returned to the S-CSCF comprises at least the user profile information.

11. A method for reducing load of Home Subscription Server (HSS)'s interface, comprising:
upon receiving a message from a I-CSCF for inquiring about the information of S-CSCF, a HSS returning to the I-CSCF an inquiry response message comprising a information needed for determining an S-CSCF; the I-CSCF determining a S-CSCF that has the capability to serve a UE and forwarding request message of the UE to the determined S-CSCF.

12. The method according to claim 11, wherein, when a Public User Identity performs registration for the first time,
if there is at least one Public User Identity of the UE requesting registration that has been registered in the HSS and the registration is still valid, and the HSS determines there is no need for the I-CSCF to re-select an S-CSCF to serve the UE, then said information needed for determining an S-CSCF comprises the name of the S-CSCF that is serving the UE;
if there is at least one Public User Identity of the UE requesting registration of which the registration status is unregistered or the registration has expired, but the HSS still stores the name of the S-CSCF that was used by the UE last time, or if the UE has been assigned an S-CSCF by the HSS as an unregistered party that is called, then said information needed for determining an S-CSCF comprises the name of the S-CSCF that has served the UE;
if HSS has stored the name of the S-CSCF that has served or is serving the UE and the HSS is not sure whether it is needed for the I-CSCF to re-select an S-CSCF to serve the UE, then said information needed for determining an S-CSCF comprises the name of the S-CSCF that has served or is serving the UE and the S-CSCF capability information set that has the capability to meet the most strict service subscription requirement of the UE requesting registration;
if there is no assigned S-CSCF that has served the UE stored in the HSS, then said information needed for determining an S-CSCF comprises the S-CSCF capability information set that has the capability to meet the most strict service subscription requirement of the UE requesting registration.

13. The method according to claim 12, wherein,
if the information returned from the HSS comprises only the name of S-CSCF, said determining the S-CSCF that has the capability to serve the UE for I-CSCF further comprises: the I-CSCF determining the S-CSCF in the returned information is the S-CSCF that has the capability to serve the UE;
if the information returned from the HSS comprises only the S-CSCF capability information set that has the capability to meet the most strict service subscription requirement of the UE requesting registration, then said determining the S-CSCF that has the capability to serve the. UE for I-CSCF further comprises: the I-CSCF selecting a new S-CSCF that has the capability to meet the current service requirement of the UE according to the S-CSCF capability information set in the returned response message, and determining the newly-selected S-CSCF as the S-CSCF that has the capability to serve the UE;
if the information returned from the HSS comprises the name of S-CSCF and S-CSCF capability information set that has the capability to meet the most strict service subscription requirement of the UE requesting registration, then said determining the S-CSCF that has the capability to serve the UE for I-CSCF further comprises: the I-CSCF deciding according to the returned name of S-CSCF whether the S-CSCF has the capability to meet the current service requirement of the UE, if yes, determining the S-CSCF in the returned information is the S-CSCF that has the capability to serve the UE, otherwise, selecting a new S-CSCF that has the capability to meet the current service requirement of the UE according to the S-CSCF capability information set in the response message, and determining the newly-selected S-CSCF as the S-CSCF that has the capability to serve the user.

14. The method according to claim 11, after the HSS receives the message for inquiring about the information of S-CSCF from the I-CSCF, further comprising: deciding according to the user's subscription information and the policy of the operator that the UE is permitted to perform a registration request in the current network before subsequent steps is executed.

15. The method according to claim 11, wherein, when a public user identifier performs registration for the first time,
the message received by the HSS from the I-CSCF for inquiring about the information of S-CSCF is carried by a Cx-Query message; and said inquiry response message returned to the I-CSCF from the HSS comprises the information needed for determining an S-CSCF is carried by a Cx-Query Resp message, or,
the message received by the HSS from the I-CSCF for inquiring about the information of S-CSCF is carried by a Cx-Select-Pull message, and said inquiry response message returned to the I-CSCF from the HSS comprises the information needed for determining an S-CSCF is carried by a Cx-Select-Pull Resp message.

16. The method according to claim 11, wherein, when the UE is in a session,
if the HSS has stored the name of the S-CSCF that has served or is serving the UE, the HSS will, according to system configuration, return to the I-CSCF a response message comprising the name of S-CSCF, and the I-CSCF will forward the session request message of the UE to the S-CSCF; or the HSS will return to the I-CSCF a response message comprising the S-CSCF name and S-CSCF capability information set that has the capability to meet the most strict service subscription requirement of the UE, and the I-CSCF will determine an S-CSCF that has the capability to serve the user and forwards the session request message of the UE to the determined S-CSCF;
if there is no S-CSCF stored in the HSS that has served the UE, the HSS will directly return to I-CSCF a response message comprising the S-CSCF capability information set that has the capability to meet the most strict service subscription requirement of the UE before I-CSCF determines an S-CSCF that has the capability to serve the UE and forwards the session request message of the UE to the determined S-CSCF.

17. The method according to claim 11, wherein, when the UE is in a session,
the message received by the HSS from the I-CSCF for inquiring about the information of S-CSCF is carried by a Cx-Location-Query message, and said inquiry response message returned to the I-CSCF from the HSS comprises the information needed for determining an S-CSCF is carried by a Cx-Location-Query Resp message, or,
the message received by the HSS from the I-CSCF for inquiring about the information of S-CSCF is carried by a Cx-Select-Pull message, and said inquiry response message returned to the I-CSCF from the HSS comprises the information needed for determining an S-CSCF is carried by a Cx-Select-Pull Resp message.
